(19) United States
(12) Patent Application Publication
(10) Pub. No.: US 2012/0297437 A1
(43) Pub. Date: Nov. 22, 2012

(54) SYSTEMS AND METHODS PROVIDING BUSINESS DATA VIA A TELEVISION BASED ON A BUSINESS CONTEXT

(76) Inventors: Guy Blank, Tel-Aviv (IL); Guy Soffer, Ra'anana (IL)

(21) Appl. No.: 13/109,476

(22) Filed: May 17, 2011

(51) Int. Cl. H04N 7/173

(52) U.S. Cl. 725/116; 725/114

(57) ABSTRACT

According to some embodiments, a stream of television information to be displayed on a television may be received. In substantially real time, the received television information may be automatically analyzed to determine a business context. Based on the determined business context and business data stored at a remote business server, an interaction with a viewer may be arranged via the television.

### FIELD

Some embodiments relate to systems and methods associated with a television. More specifically, some embodiments are directed to systems and methods to automatically provide business data via a television based on a business context.

### BACKGROUND

An increasingly wide variety of information, including financial news, is available through television programs. In particular, satellite and cable television channels provide real-time information from around the world that may be important to a business or enterprise. For example, an announcement that a company has been sold may be of interest to customers and/or suppliers associated with that company. Note, however, the context or type of information being provided by a television channel constantly changes (e.g., a program about recent environmental trends might be unexpectedly interrupted by a breaking news story about a bankruptcy filing).

Many companies also have access to a significant amount of data through business systems. For example, information about sales and purchase orders, work emails, and profit estimates might be readily available from a company's enterprise resource planning system and/or web-based portal platform.

A viewer watching television might see or hear important information that is relevant to his or her business (e.g., financial news). There is no way, however, to automatically (without human interaction) identify this information. Moreover, there is no way of associating data from business systems with the information being received through the television, nor is there a way to take business actions through the television.

Accordingly, methods and mechanisms to efficiently, accurately, and automatically display business data via a television based on a business context may be provided in accordance with some embodiments described herein.

### BRIEF DESCRIPTION OF THE DRAWINGS

FIG. 1 is a block diagram of a system according to some embodiments.

FIG. 2 is a flow diagram of a process in accordance with some embodiments.

FIG. 3 illustrates a television display in accordance with some embodiments.

FIG. 4 illustrates a business data connection configuration display in accordance with some embodiments.

FIG. 5 illustrates a business data notification display in accordance with some embodiments.

FIG. 6 illustrates a supplemental business data display in accordance with some embodiments.

FIG. 7 illustrates a business contact or messaging data display in accordance with some embodiments.

FIG. 8 is a block diagram of system according to one embodiment.

FIG. 9 is a block diagram of an apparatus according to some embodiments.

FIG. 10 illustrates a portion of a tabular database that might be stored in accordance with some embodiments.

### DETAILED DESCRIPTION

An increasingly wide variety of information, including financial news, is available through television programs. It is further noted that the “context” or type of information being provided by a television channel constantly changes. Many companies also have access to a significant amount of data through business systems. For example, information about sales and purchase orders, work emails, and profit estimates might be readily available from a company's enterprise resource planning system and/or web-based portal platform.

A viewer watching television might see or hear important information that is relevant to his or her business (e.g., financial news). There is no way, however, to automatically (without human interaction) identify this information. Moreover, there is no way of associating data from business systems with the information being received through the television, nor is there a way to take business actions through the television.

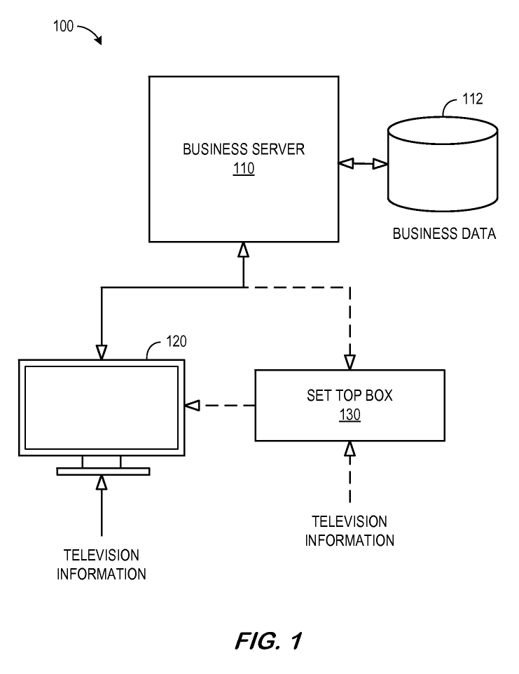

Accordingly, methods and mechanisms to efficiently, accurately, and automatically display business data via a television based on a business context may be provided in accordance with some embodiments described herein. For example, FIG. 1 is a block diagram 100 of a system according to some embodiments. The system 100 includes a business server 110 coupled to one or more databases or data stores containing business data 112. By way of example only, the business server 110 might be associated with an Enterprise Resource Planning (ERP) server, a business services gateway, a HyperText Transfer Protocol (HTTP) server, and/or an Advanced Business Application Programming (ABAP) server.

According to some embodiments (illustrated by a solid arrow in FIG. 1), the business server 110 may directly communicate with a television 120. According to other embodiments, a gateway may be provided between the business server 110 and the television 120. The television 120 may include one or more processors to decode a received television signal and/or to execute applications and/or components (e.g., a plug-in that is integrated to a television). By way of example only, the television 120 might be associated with a digital television, a GOOGLE television, a Boxee device, a MediaPortal television, a set top box, a digital video recorder, and/or a MICROSOFT Media Center. The television 120 may receive television information 120 and provide image and audio information to a viewer. By way of example only, the received television information might be associated with a broadcast signal, a cable signal, a satellite signal, the H.264 protocol, the Moving Pictures Expert Group (MPEG) 2 protocol, the MPEG 4 protocol, or Internet Protocol TeleVision (IPTV) information.

According to other embodiments, a set top box 130 (e.g., a cable box or media center) may be located between the business server 110 and the television 120 (illustrated by dashed arrows in FIG. 1). In this case, the set top box 130 might receive a television signal, receive business data 112 from the business server 110 and provide a signal to the television 120.

Note that FIG. 1 represents a logical architecture for the system 100 according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 1, including the business server 110, television 120, and/or set top box 130 may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

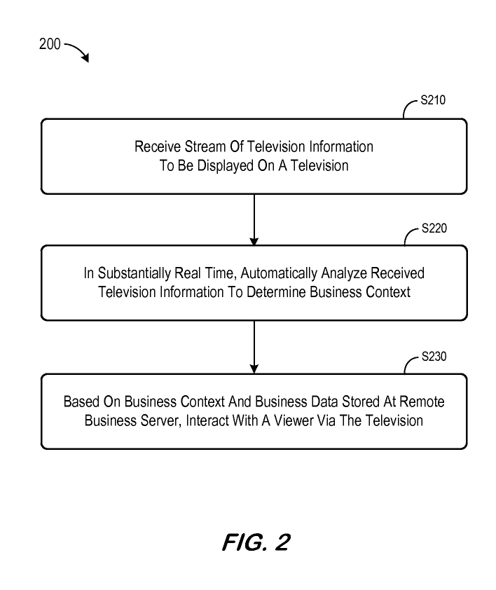

FIG. 2 is a flow diagram of a process 200 that might be associated with the television 120 or set top box 130 of FIG. 1 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S210, a stream of television information to be displayed on a television may be received. By way of example only, the received stream of television information might be associated with a broadcast signal, a cable signal, a satellite signal, the H.264 protocol, the MPEG2 protocol, the MPEG 4 protocol, and/or IPTV information. The information might be received, for example, by a television or a set-top box.

According to some embodiments, the received television information may be “automatically” analyzed at S220, in substantially real time, to determine a business context. As used herein, the term “automatically” may refer to an operation or process performed with little or no human intervention. The business “context” of the television information might refer to, for example, a subject matter being discussed on a television program.

According to some embodiments, at least one business “keyword” may be received from a remote business server. The “keyword” might comprise, for example, a string of alphanumeric characters associated with a client name, a customer name, a product name, a service name, a geographic location (e.g., Peru or Asia, a Business Object (BO), and/or an entity (e.g., the University of Miami, the New York Stock Exchange, or the Federal Drug Administration).

The received stream of television information may include audio information. In this case, a speech-to-text operation may be performed on the audio information to generate television text information. The television text information might represent, for example, a transcript of an interview between a news anchor and a Chief Executive Officer (CEO) of a corporation. The television text information may then be searched looking for the at least one business keyword. For example, the television text information might be searched to see if (and when) the phrase “Company, Inc.” is mentioned. In some cases, closed caption information is also received in connection with a television signal. In this case, the closed caption information might be searched instead of, or in additional to, the result of a speech-to-text operation.

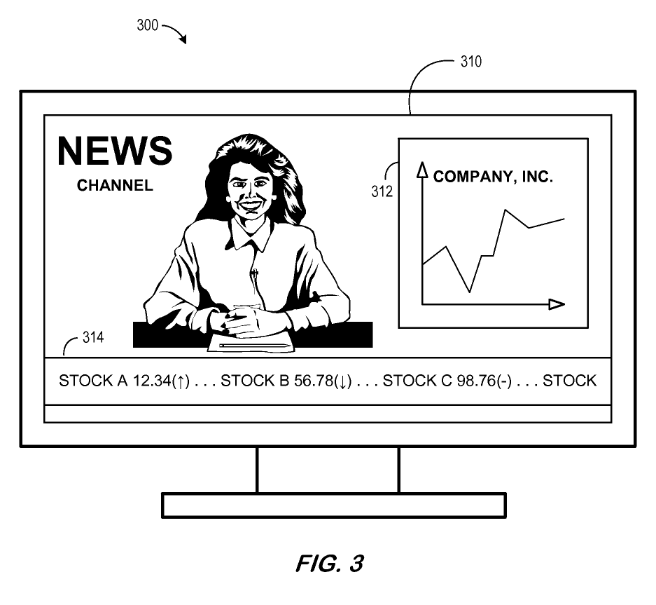

The received stream of television information may also include image information. In this case, an Optical Character Recognition (OCR) operation might be performed on the image information to generate television text information. For example, FIG. 3 is an example of a television 300 showing a television display 310 in accordance with some embodiments. The television display 310 may include, for example, static text 312 (e.g., a chart or bullet points) and/or dynamic text 314 (e.g., a stock ticker scrolling across the bottom of the display). An OCR operation might then be performed on the static text 312 and/or dynamic text 314. According to some embodiments, the television text information is searched looking for the at least one business keyword. For example, the television text information might be searched to see if (and when) the phrase “automobile manufacturers” is mentioned.

In some cases, a received stream of television information may include Electronic Programming Guide (EPG) information. The EPG information might include, for example, a description of what will be discussed on a television program. In this case, the EPG information may be searched to look for the at least one business keyword. Note that any combination of audio, image, and/or EPG information may be associated with embodiments described herein.

Based on the determined business context and business data stored at a remote business server, an interaction with a viewer may be arranged at S230 via the television. According to some embodiments, the interaction may be associated with providing supplemental business information to the viewer. The supplemental business information might be associated with, by way of example only, enterprise data, sales data, profit data, order data, human resources data, contact data, and/or message data (e.g., a list of email messages between the viewer and a client currently being discussed on a television program).

According to some embodiments, the interaction via the television may be associated with receiving input from the viewer. The received input might be, for example, associated with a display selection (e.g., he or she might select a product from a group of potential products being discussed on a television program), message data (e.g., the viewer might compose an email), and/or a business action (e.g., placing a purchase order on hold). According to some embodiments, the input from the viewer is received via a television remote control device (e.g., an infrared or Bluetooth remote control device).

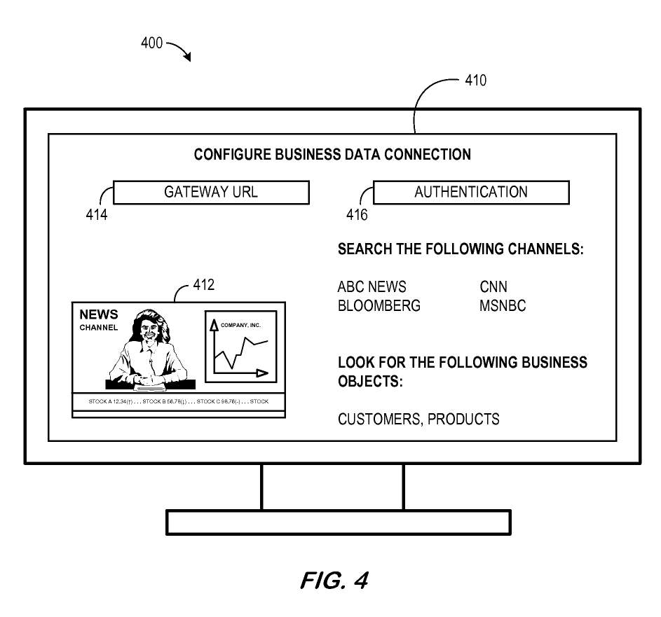

The viewer might, according to some embodiments, initially configure or occasionally adjust his or her system and/or preferences. For example, FIG. 4 is one example of a television 400 showing a business data connection configuration display 410 in accordance with some embodiments. The configuration display 410 might be used, for example, by a viewer to select or enter a Uniform Resource Locator (URL) address associated with a business gateway server 414 or to select or initiate an authentication process 414. The configuration display 410 could also be used to define a set of broadcast channels to be searched or monitored (e.g., in addition to the channel he or she is watching) and/or define what business information should be associated with the search (e.g., customers and products).

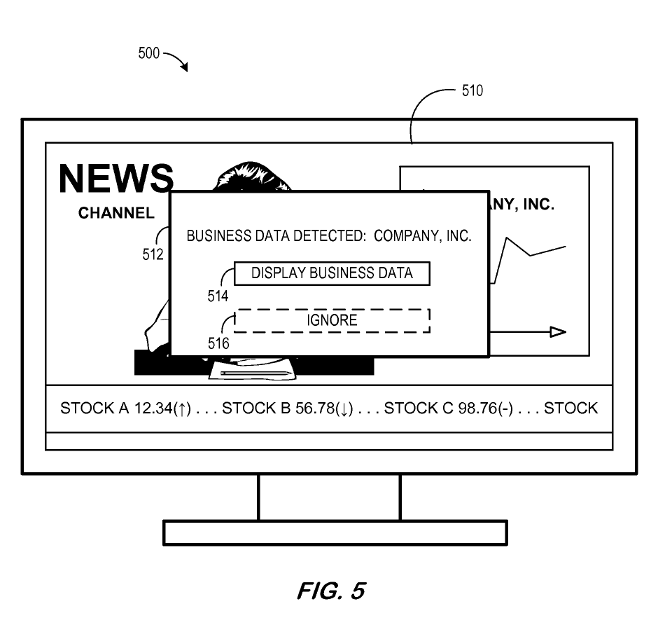

When the system detects that television information is associated with a context that meets a pre-defined criteria (e.g., the word “Company, Inc.” was spoken or displayed on the television channel currently being watched), the viewer may be notified. For example, FIG. 5 is one example of a television 500 showing a business data notification display 510 in accordance with some embodiments. In this case, a popup window 512 may be displayed to show the viewer what business context information has been detected. The viewer may then select to display the business data 514 or ignore 516 the information. According to some embodiments, the viewer may make such a selection via a television remote control device. Note that any other user interface may be implemented according to embodiments described herein. Moreover, according to some embodiments the system may learn and improve upon a detection algorithm based on the user's feedback (e.g., as the system determines which contexts may be of interest to him or her).

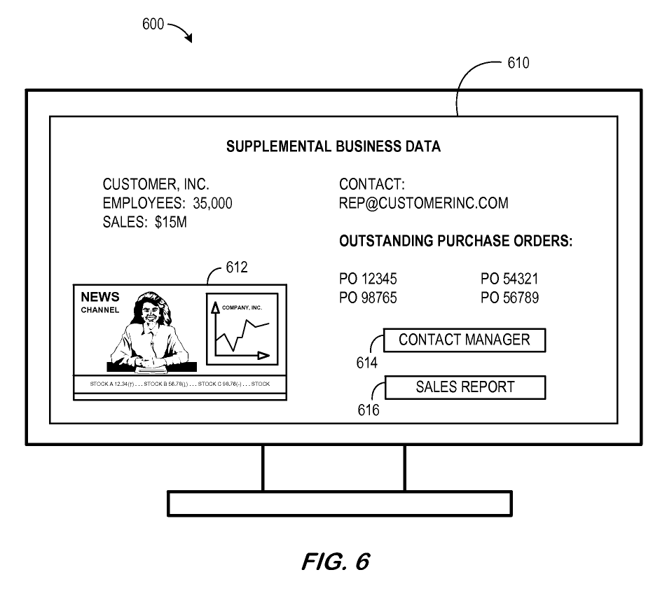

If the viewer selects to display the business data 514, supplemental business data (e.g., from a remote business gateway or ERP system) may be provided. For example, FIG. 6 is one example of a television 600 showing a supplemental business data display 610 in accordance with some embodiments. The supplemental business data display 610 might include, for example, a company name, financial data, news stories, and/or human resources information associated with the business context of the original television information. Note that the supplemental data might be overlaid on the original television content or provided as a picture-in-a-picture display 612 (as illustrated in FIG. 6).

According to some embodiments, the supplemental business data display 610 may let a viewer take a business action. For example, the viewer might select to contact a manager 614 or view a sales report 616 associated with the supplemental business data.

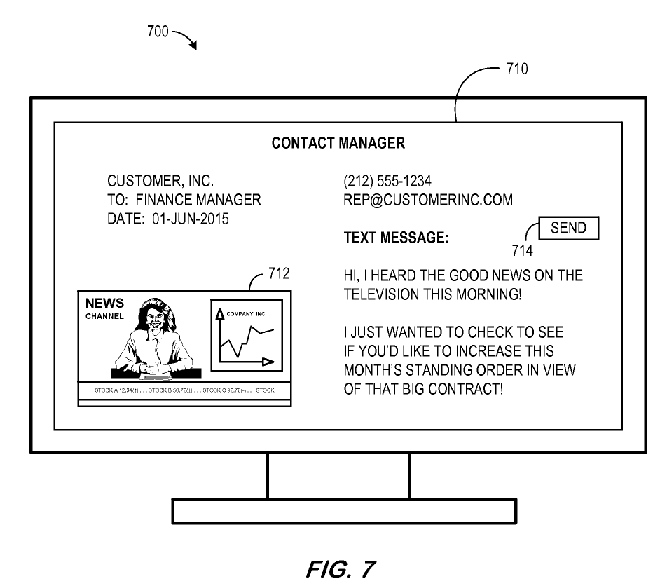

If the viewer selects to contact a manager 614 associated with the supplemental business data, he or she may be taken to an email or messaging application. Note that this might apply to email, messaging, or any other external feature. Moreover, it might be implemented as part of the invention without the need to connect with an external application. For example, FIG. 7 is one example of a television 700 showing a business contact or messaging data display 710 in accordance with some embodiments. As before, this information might be overlaid on the original television content or provided as a picture-in-a-picture display 712 (as illustrated in FIG. 6). The messaging data display 710 may be used by the viewer, for example, to send 714 a text message via email and/or a business messaging system. According to some embodiments, a viewer might attach audio and/or video information to the message (e.g., a clip from the television show he or she was watching) and/or a transcript of the audio and/or video (e.g., using a speech-to-text process).

By way of example, a viewer might watch television using any open source media center system, such as MediaPortal or any other open source system. He or she might use a configuration display (e.g., as described with respect to FIG. 4 to configure a connection with a company business gateway sets up the system to receive alerts for a particular television channel. Moreover, he or she arranges to receive alerts when any of the company's customers are mentioned on that television channel (note that the names of customers and products may be coming from a service exposed on the gateway). The system may use a speech-to-text engine to look for mentions of any customer in substantially real-time.

At some point, the system detects that Customer, Inc. was just mentioned on the television (e.g., “the stock price of Customer, Inc. is on the decline”) and a notification may be provided (such as described with respect to FIG. 5). The viewer may be interested in receiving more detail, and, as a result, supplemental business information may be displayed (such as described with respect to FIG. 6). The viewer might see that the company has 30 sales orders pending from Customer, Inc. and he or she may be concerned about getting paid for those orders. The viewer may then send an email to a contact person asking him or her for a meeting tomorrow morning. This may be done, for example, directly via the television using a remote control (as described with respect to FIG. 7).

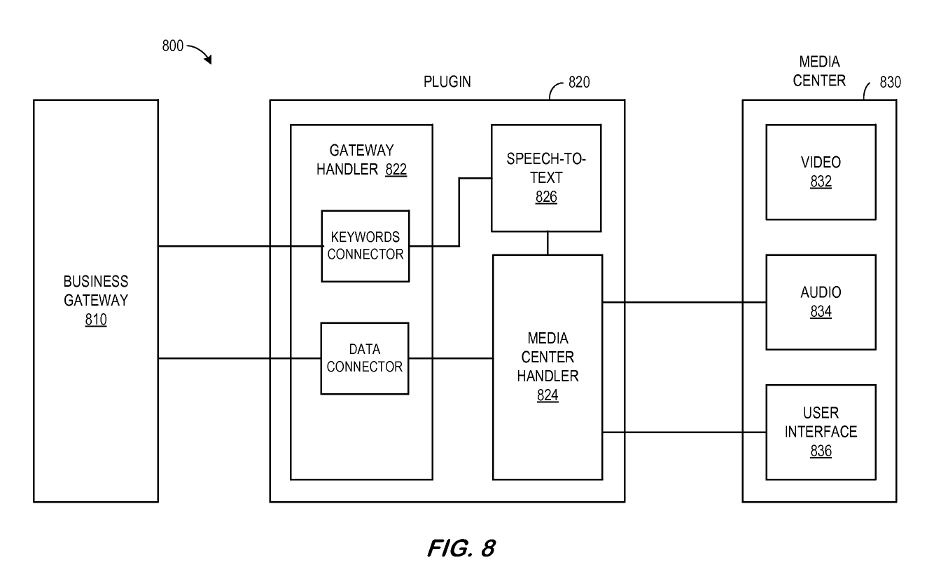

FIG. 8 is a block diagram of system 800 according to one embodiment. In particular, the system 800 includes a business gateway 810 that exchanges information with a plugin 820 (e.g., via a gateway handler 822). The gateway 810 might, for example, handle interactions with an ABAP business system that exposes data that can be consumed by a standard Application Programming Interface (API). The plugin 820 might, for example, execute at a media center 830. According to some embodiments, the media center 830 may comprise an audio/visual software application or a dedicated media player device. The media center 830 may process television information via a video component 832 and, according to some embodiments, support a plugin and/or extension infrastructure.

A media center handler component 824 of the plugin 820 might consume television audio in substantially real-time being played on the media center 830 (e.g., by an audio component 834). The media center handler component 824 might also be responsible for any User Interface (UI) that should be displayed by the media center 830 (e.g., via a UI component 836). This might be done, for example, using an API exposed by the media center 830.

The media center handler component 824 may also send the audio stream to a speech-to-text component 826 for processing. According to some embodiments, the media center handler component 824 also sends the video stream (for OCR processing) and/or EPG information to an appropriate search component. The media center handler component 824 may also call a data connector component (which is part of the gateway handler 822) on demand to get related data from a remote business system.

The speech-to text component 826 may be responsible for matching the received television content and one or more keywords that represent data from the remote business system. Moreover, the speech-to text component 826 may be responsible for analyzing any input data source from the media center 830 in order to identify related business context (e.g., using a speech-to-text engine that converts spoken words to text). According to some embodiments, the speech-to text component 826 can also process video (OCR processing) and/or EPG information. In some cases, the speech-to text component 826 may request a list of keywords from the gateway handler 822 (which represents data from the business system). For example, a keywords connector of the gateway handler 822 might request business data from the business gateway 810, convert the data to a list of keywords (e.g., customer names and product names) that are used by the speech-to text component 826.

The speech-to text component 826 may then search for the keywords inside the media content. When a match is found, the data connector of the gateway handler 822 may the use a standard API to request business data on demand based on the context detected by the plugin 820.

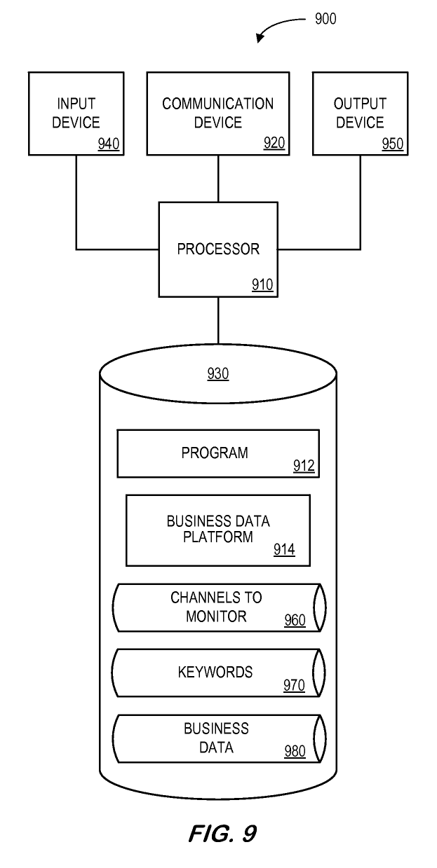

Note that the architecture described with respect to FIG. 8 is provided only as an example, and any other type of apparatus might be provided instead. For example FIG. 9 is a block diagram overview of one such apparatus 900 according to some embodiments. The apparatus 900 may be, for example, associated with a television and/or media center. The apparatus 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used, for example, as an input path to receive television and/or business system data. The apparatus 900 further includes an input device 940 (e.g., a mouse and/or keyboard to enter configuration, messaging, and/or business activity information) and an output device 950 (e.g., a computer monitor to display supplemental business information).

The processor 910 communicates with a storage device 930. The storage device 930 may comprise any appropriate information storage device, including combinations of magnetic storage devices (e.g., a hard disk drive), optical storage devices, and/or semiconductor memory devices. The storage device 930 stores a program 912 and/or business data platform 914 for controlling the processor 910. The processor 910 performs instructions of the programs 912, 914, and thereby operates in accordance with any of the embodiments described herein. For example, the processor 910 may receive and/or decode a stream of television information to be displayed on a television. In substantially real time, the received television information may be automatically analyzed by the processor 910 to determine a business context. Based on the determined business context and business data stored at a remote business server, the processor 910 may arrange an interaction with a viewer may be via the television.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

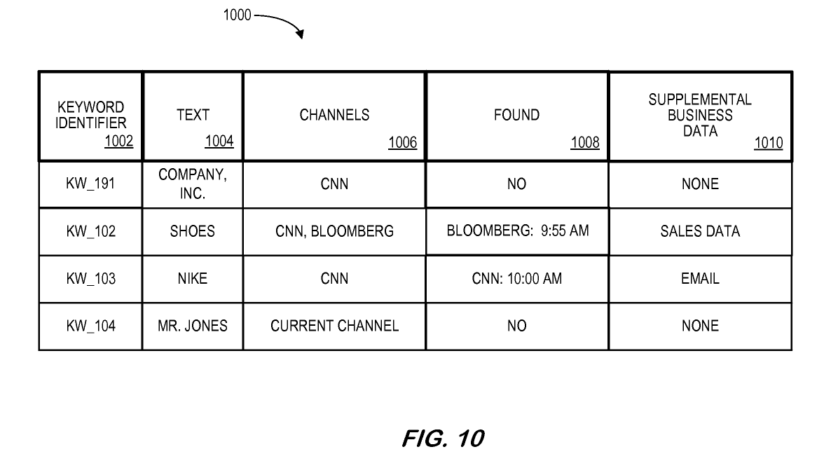

In some embodiments (such as shown in FIG. 9), the storage device 930 stores which channels should be monitored 960, one or more keywords 970, and business data 980 (e.g., received from a remote business system). An example of a keyword database 1000 that may be used in connection with the apparatus 900 will now be described in detail with respect to FIG. 10. Note that the database described herein is only an example, and additional and/or different information may be stored therein. Moreover, various databases might be split or combined in accordance with any of the embodiments described herein.

Referring to FIG. 10, a table is shown that represents the keyword database 1000 that may be stored at the sales engine 700 according to some embodiments. The table may include, for example, entries identifying keyword data associated with a remote business system. The table may also define fields 1002, 1004, 1006, 1008, 1010 for each of the entries. The fields 1002, 1004, 1006, 1008, 1010 may, according to some embodiments, specify: a keyword identifier 1002, text 1004, channels 1006, an indication of if and when/where the keyword was found 1008, and supplemental business data 1010. The information in the keyword database 1000 may be created and updated, for example, based on data received from a remote business system and/or a viewer.

The keyword identifier 1002 may be, for example, a unique alphanumeric code identifying a keyword that has been (or may be) detected in a television stream. The text 1004 may represent the information that should be searched for by a speech-to-text converter. The channels 1006 might list which television channels should be monitored (e.g., in addition to the one currently being viewed). The indication of if and when/where the keyword was found 1008 might, for example, reveal that the keyword has not yet been found or that it was found an a particular channel at a particular time. The supplemental business data 1010 may indicate what data was provided to the viewer based on the discovered business context.

Thus, some embodiments may establish methods and mechanisms to efficiently, accurately, and automatically provide business data via a television based on a business context. Moreover, embodiments may let business user get real time contextual data from their business systems related to what is currently being shown on television. According to some embodiments, an alert may be displayed on the television screen whenever relevant business context is detected. Moreover, related information from the viewer's business systems may be provided. Still further, embodiments may let a viewer perform business actions using a television as the user interface.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to business systems, note that embodiments may be associated with other types of enterprise data. For example, financial, governmental, and/or medical information may be processed in accordance with any of the embodiments described herein.

Moreover, while embodiments have been illustrated using particular ways to determine context, embodiments may be implemented in any other of a number of different ways. For example, some embodiments might be associated with context detection performed with a facial recognition application (e.g., when a particular company president is shown on the television) or a product recognition application (e.g., to detect that celebrity is wearing or using a product).

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
receiving a stream of television information to be displayed on a television;
in substantially real time, automatically analyzing the received television information to determine a business context; and
based on the determined business context and business data stored at a remote business server, interacting with a viewer via the television.

2. The method of claim 1, wherein the received stream of television information is associated with at least one of: (i) a broadcast signal, (ii) a cable signal, (iii) a satellite signal, (iv) the H.264 protocol, (v) the Moving Pictures Expert Group (MPEG) 2 protocol, (vi) the MPEG 4 protocol, or (vii) Internet Protocol TeleVision information.

3. The method of claim 1, further comprising:
receiving at least one business keyword from the remote business server.

4. The method of claim 3, wherein the at least one business keyword is associated with at least one of: (i) a client name, (ii) a customer name, (iii) a product name, (iv) a service name, (v) a geographic location, (vi) a business object, or (vii) an entity.

5. The method of claim 3, wherein the received stream of television information includes audio information and said analyzing comprises:
performing a speech-to-text operation on the audio information to generate television text information; and
searching the television text information looking for the at least one business keyword.

6. The method of claim 3, wherein the received stream of television information includes image information and said analyzing comprises:
performing an optical character recognition operation on the image information to generate television text information; and
searching the television text information looking for the at least one business keyword.

7. The method of claim 3, wherein the received stream of television information includes electronic programming guide information and said analyzing comprises:
searching the electronic programming guide information looking for the at least one business keyword.

8. The method of claim 1, wherein said interacting comprises providing supplemental business information to the viewer.

9. The method of claim 8, wherein the supplemental business information is associated with at least one of: (i) enterprise data, (ii) sales data, (iii) profit data, (iv) order data, (v) human resources data, (vi) contact data, or (vii) message data.

10. The method of claim 1, wherein said interacting comprises receiving input from the viewer.

11. The method of claim 10, wherein the received input is associated with at least one of: (i) a display selection, (ii) message data, (iii) a business action.

12. The method of claim 10, wherein the input from the viewer is received via a television remote control device.

13. The method of claim 1, wherein the television is associated with at least one of: (i) a digital television, (ii) a GOOGLE television, (iii) a Boxee device, (iv) a MediaPortal television, (v) a set top box, (vi) a digital video recorder, or (vii) a MICROSOFT Media Center.

14. The method of claim 1, wherein the remote business server is associated with at least one of: (i) an enterprise resource planning server, (ii) a business services gateway, (iii) a hypertext transfer protocol server, or (iv) an Advanced Business Application Programming server.

15. A non-transitory, computer-readable medium storing program code executable by a computer to:
receive a stream of television information to be displayed on a television;
in substantially real time, automatically analyze the received television information to determine a business context; and
based on the determined business context and business data stored at a remote business server, interact with a viewer via the television.

16. The medium of claim 1, further storing program code executable by the computer to:
receive at least one business keyword from the remote business server.

17. The medium of claim 16, wherein the received stream of television information includes audio information and said analyzing comprises:
performing a speech-to-text operation on the audio information to generate television text information; and
searching the television text information looking for the at least one business keyword.

18. The medium of claim 17, wherein the received stream of television information includes image information and said analyzing comprises:
performing an optical character recognition operation on the image information to generate television text information; and
searching the television text information looking for the at least one business keyword.

19. A system, comprising:
an input path to receive a stream of television information to be displayed on a television;
a business data platform coupled to the input path, to:
in substantially real time, automatically analyze the received television information to determine a business context; and
based on the determined business context and business data stored at a remote business server, interact with a viewer via the television.

20. The system of claim 19, wherein said analyzing is performed by a media device plugin application.

21. The system of claim 19, further comprising:
a keyword connector to receive at least one keyword from the remote business server, and
a search engine to search the television information looking for the at least one keyword.
